(19) United States
(12) Patent Application Publication
(10) Pub. No.: US 2011/0124317 A1
(43) Pub. Date: May 26, 2011

(54) Clone detection method, and mobile terminal and mobile communication system using the same

(75) Inventor: Jae Seok Joo, Seongnam-si (KR)

(73) Assignee: Samsung Electronics Co., Ltd., Suwon-si (KR)

(21) Appl. No.: 12/925,747

(22) Filed: Oct. 28, 2010

(30) Foreign Application Priority Data
Nov. 20, 2009 (KR) 10-2009-0112504

(51) Int. Cl. H04W 12/12; H04W 4/02

(52) U.S. Cl. 455/411; 455/456.1

(57) ABSTRACT

A clone terminal detection method is disclosed. The clone detection method for a mobile terminal includes: determining, when a call request is made, by the mobile terminal, a current location and time; sending the current location and time data to a mobile communication system; receiving a pre-stored location and time data of the mobile terminal from the mobile communication system; computing a travel speed of the mobile terminal using the current location and time data and the pre-stored location and time data; comparing the computed travel speed with a preset threshold speed; and determining, when the travel speed is greater than or equal to the threshold speed, that the mobile terminal is a clone terminal.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 20, 2009 and assigned Serial No. 10-2009-0112504, the entire disclosure of which is hereby incorporated by reference.

### TECHNICAL FIELD OF THE INVENTION

The present invention relates to detection of clone mobile terminals and, more particularly, to a method that can detect a clone mobile terminal on the basis of location information and to a mobile terminal and mobile communication system using the same.

### BACKGROUND OF THE INVENTION

With rapid popularization, mobile terminals have become a necessity of modern life. Under these circumstances, cloning of mobile terminals is increasingly common. A perpetrator may illegitimately create a clone mobile terminal in order to avoid paying call charges or for the purpose of invasion of privacy. A legitimate subscriber may become a victim of mobile cloning. For example, the legitimate subscriber may be forced to pay charges for mobile communication services used by the perpetrator, may experience inconvenience in service usage owing to interference or signal quality reduction, or may be harmed by privacy invasion.

Existing schemes for detecting clone mobile terminals employing traffic pattern analysis or authentication techniques may require special purpose equipment that is not only inefficient but also expensive to operate.

### SUMMARY OF THE INVENTION

To address the above-discussed deficiencies of the prior art, it is a primary object to provide a method that can detect a clone mobile terminal in an accurate and rapid fashion without employing special purpose equipment.

The present invention also provides a mobile terminal and mobile communication system using the clone detection method.

In accordance with an exemplary embodiment of the present invention, there is provided a clone detection method for a mobile terminal, including: determining, when a call request is made, by the mobile terminal, a current location and time; sending the current location and time data to a mobile communication system; receiving a pre-stored location and time data of the mobile terminal from the mobile communication system; computing a travel speed of the mobile terminal using the current location and time data and the pre-stored location and time data; comparing the computed travel speed with a preset threshold speed; and determining, when the travel speed is greater than or equal to the threshold speed, that the mobile terminal is a clone terminal.

In accordance with another exemplary embodiment of the present invention, there is provided a mobile terminal including: a GPS module configured to receive GPS signals from GPS satellites; a radio frequency unit configured to send a current location and time data to a mobile communication system, and receive a pre-stored location and time data of the mobile terminal from the mobile communication system; and a control unit configured to determine a current location and time of the mobile terminal using the GPS signals received through the GPS module, compute a travel speed of the mobile terminal using the current location and time data and the pre-stored location and time data, compare the computed travel speed with a preset threshold speed, and determine, when the travel speed is greater than or equal to the threshold speed, that the mobile terminal is a clone terminal.

In accordance with another exemplary embodiment of the present invention, there is provided a clone terminal detection method for a mobile communication system, including: receiving a current location and time data of a mobile terminal from the mobile terminal; retrieving a location and time data of the mobile terminal pre-stored prior to reception of the current location and time data; computing a travel speed of the mobile terminal using the current location and time data and the pre-stored location and time data; comparing the computed travel speed with a preset threshold speed; and determining, when the travel speed is greater than or equal to the threshold speed, that the mobile terminal is a clone terminal.

In accordance with another exemplary embodiment of the present invention, there is provided a mobile communication system including: a wireless communication unit configured to receive a current location and time data of a mobile terminal from the mobile terminal; a location information database configured to store one or more pieces of location and time data received from the mobile terminal; a clone terminal detector configured to retrieve a most recently stored location and time data of the mobile terminal except for a current location and time data from the location information database, compute a travel speed of the mobile terminal using the received current location and time data and the retrieved most recently stored location and time data, compare the computed travel speed with a preset threshold speed, and determine, when the travel speed is greater than or equal to the threshold speed, that the mobile terminal is a clone terminal.

In a feature of the present invention, the user of a mobile terminal may determine whether the mobile terminal has been clone without using a specialized tool. In addition, the mobile service provider may accurately and rapidly detect clone mobile terminals.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system for detecting a clone mobile terminal according to the present invention;

FIG. 2 is a sequence diagram illustrating a procedure for detecting a clone mobile terminal in the clone detection system according to a first embodiment of the present invention;

FIG. 3 is a block diagram illustrating a mobile terminal capable of clone detection according to the procedure of FIG. 2;

FIG. 4 is a flow chart of a clone detection procedure for the mobile terminal of FIG. 3;

FIG. 5 is a sequence diagram illustrating a procedure for detecting a clone mobile terminal in the clone detection system according to a second embodiment of the present invention;

FIG. 6 illustrates components of a mobile communication system implementing the procedure of detecting a clone mobile terminal in FIG. 5;

FIG. 7 is a flow chart of the clone detection procedure for the mobile communication system of FIG. 6; and

FIG. 8 illustrates detection of a clone mobile terminal on the basis of location information.

### DETAILED DESCRIPTION OF THE INVENTION

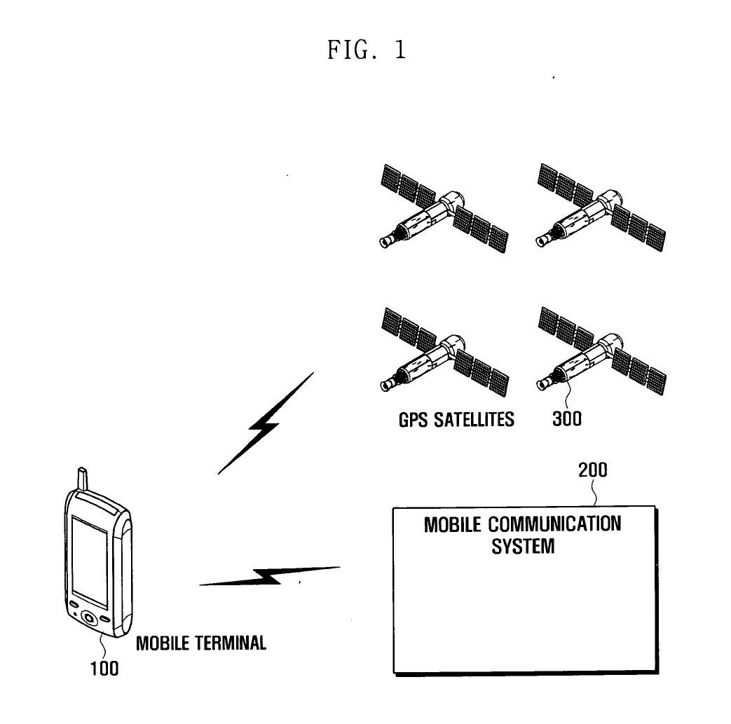

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Detailed descriptions of well-known functions and structures incorporated herein may be omitted to avoid obscuring the subject matter of the present invention. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various embodiments is to be construed as exemplary only and does not describe every possible instance of the invention. Therefore, it should be understood that various changes may be made and equivalents may be substituted for elements of the invention.

The mobile terminal of the present invention may be one of an international mobile telecommunications 2000 (IMT 2000) terminal, wideband code division multiple access (WCDMA) terminal, global system for mobile communications (GSM)/general packet radio services (GPRS) terminal, and universal mobile telecommunications system (UMTS) terminal.

In the description, “mobile terminal” may refer to a legitimate mobile terminal or a clone mobile terminal. The “mobile communication system” refers to a network system that provides mobile communication services to subscribers. The mobile communication system may include a base station (BS), a base station controller (BSC) controlling the base station, a mobile switching center (MSC), a home location register (HLR) storing and managing information regarding registered mobile terminals, a visitor location register (VLR) storing and managing information regarding visiting mobile terminals, and a gateway leading to a specific server. The mobile communication system may further include a location information database storing location and time information related to mobile terminals. The location information database may reside in one of the base station, base station controller, mobile switching center, home location register and visitor location register, or may be externally connected thereto.

FIG. 1 illustrates a system for detecting a clone mobile terminal according to the present invention. The system includes a mobile terminal 100, a mobile communication system 200 and GPS (Global Positioning System) satellites 300.

The mobile terminal 100 may be a clone terminal of a perpetrator or the original terminal of a legitimate subscriber. The mobile terminal 100 receives GPS signals from the GPS satellites 300, determines the current location and time of the mobile terminal 100 using the received GPS signals, and sends the current location and time data to the mobile communication system 200. In a first embodiment, the mobile terminal 100 receives pre-stored location and time data from the mobile communication system 200, computes the travel speed of the mobile terminal 100 using the current location and time data and the previous location and time data from the mobile communication system 200, and determines whether the mobile terminal 100 is a clone terminal on the basis of the travel speed.

The mobile communication system 200 is a network system providing mobile communication services to subscribers. The mobile communication system 200 may include a base station, a base station controller controlling the base station, a mobile switching center, a home location register storing and managing information regarding registered mobile terminals, a visitor location register storing and managing information regarding visiting mobile terminals, and a gateway leading to a specific server. The mobile communication system 200 may further include a location information database storing location and time information related to mobile terminals. The location information database may reside in one of the base station, base station controller, mobile switching center, home location register and visitor location register, or may be externally connected thereto. The mobile communication system 200 receives current location and time data from the mobile terminal 100 and stores the current location and time data in the location information database, and retrieves stored location and time data of the mobile terminal 100 from the location information database. In a second embodiment, mobile communication system 200 computes the travel speed of the mobile terminal 100 using the received current location and time data and the retrieved location and time data from the location information database, and determines whether the mobile terminal 100 is a clone terminal on the basis of the travel speed.

The GPS satellites 300 transmit GPS signals to the mobile terminal 100. In the case of Assisted GPS (A-GPS), the GPS satellites 300 may transmit GPS signals directly to the mobile communication system 200, and the mobile communication system 200 may include a location server. When it is possible for the mobile terminal 100 to receive the current location and time data from the mobile communication system 200, the GPS satellites 300 may be excluded from the system of FIG. 1. The GPS satellites 300 broadcast radio signals to enable GPS receivers on or near the Earth's surface to determine their location and synchronized time. The mobile terminal 100 may receive GPS signals from at least five GPS satellites. The GPS satellites 300 broadcast GPS signals using L1 and L2 frequencies. The Coarse/Acquisition (C/A) code is transmitted on the L1 frequency, and the Precision (P) code is transmitted on the L1 and L2 frequencies.

Hereinabove, a description is given of the system for detecting a clone mobile terminal. Next, a description is given of a method of detecting a clone mobile terminal. Two embodiments of the method are depicted. In the first embodiment, the clone detection function is performed by the mobile terminal 100. In the second embodiment, the clone detection function is performed by the mobile communication system 200.

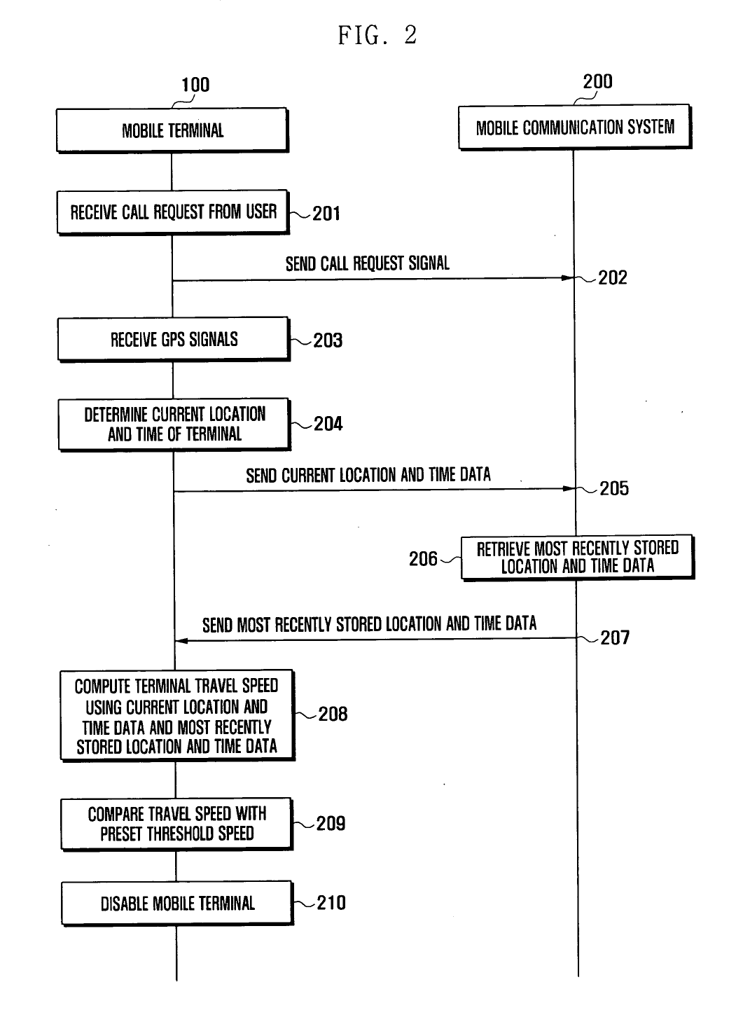

FIG. 2 is a sequence diagram illustrating a procedure for detecting a clone mobile terminal in the clone detection system according to the first embodiment of the present invention. FIG. 2 is focused on the mobile terminal 100 and mobile communication system 200.

Referring to FIG. 2, the mobile terminal 100 receives a call request from the user (201). The user may make a call request by entering a ‘call’ key of the mobile terminal 100. The mobile terminal 100 sends a call request signal to the mobile communication system 200 (202). Alternatively, the mobile terminal 100 may send a call request signal together with the current location and time data to the mobile communication system 200 later at block 205.

The mobile terminal 100 receives GPS signals from the GPS satellites 300 (203). The mobile terminal 100 may activate an internal GPS module to receive GPS signals. The mobile terminal 100 determines its current location and time using the received GPS signals (204). The mobile terminal 100 sends the current location and time data to the mobile communication system 200 (205). Upon reception of the current location and time data from the mobile terminal 100, the mobile communication system 200 retrieves the most recent location and time data of the mobile terminal 100 stored prior to the current time and stores the received current location and time data (206). Specifically, the mobile communication system 200 includes a location information database, which stores location information of mobile terminals matched with time information. The mobile communication system 200 retrieves the most recent location and time data of the mobile terminal 100 from the location information database. Here, the location and time data received from the mobile terminal 100 and the location and time data retrieved from the location information database may have originated from different mobile terminals that are regarded as being identical (i.e., original terminal and clone terminal). The mobile communication system 200 sends the most recent location and time data to the mobile terminal 100 (207).

The mobile terminal 100 receives the most recent location and time data from the mobile communication system 200 as the previous location and time data, and computes its travel speed on the basis of the current location and time and the previous location and time data (208). Here, location data includes latitude and longitude. The mobile terminal 100 may find the distance between the current location and previous location using latitude and longitude values in the current and previous location data, find the time difference using the current and previous time data, and compute the travel speed by dividing the distance by the time difference.

The mobile terminal 100 compares the computed travel speed with a preset threshold speed (209). The threshold speed may be set to a value greater (but not much greater) than the maximum travel speed of a subscriber carrying a mobile terminal. For example, a threshold speed of 50 km/h may result in misidentifying a legitimate terminal as a clone terminal. On the contrary, a threshold speed of 100000 km/h or 30 km/s may result in determining a clone terminal as a legitimate terminal, causing ineffective clone detection. The threshold speed may be empirically determined to be an adequate value (for example, 1000 km/h).

When the travel speed is greater than the threshold speed, the mobile terminal 100 disables itself (210). For disablement, the mobile terminal 100 may format an internal storage unit to destroy stored programs and data. Alternatively, the mobile terminal 100 may display an alert message “clone terminal” at block 210.

In the first embodiment, the clone detection function is performed by the mobile terminal 100. Next, a description is given of the configuration of the mobile terminal 100 capable of clone detection.

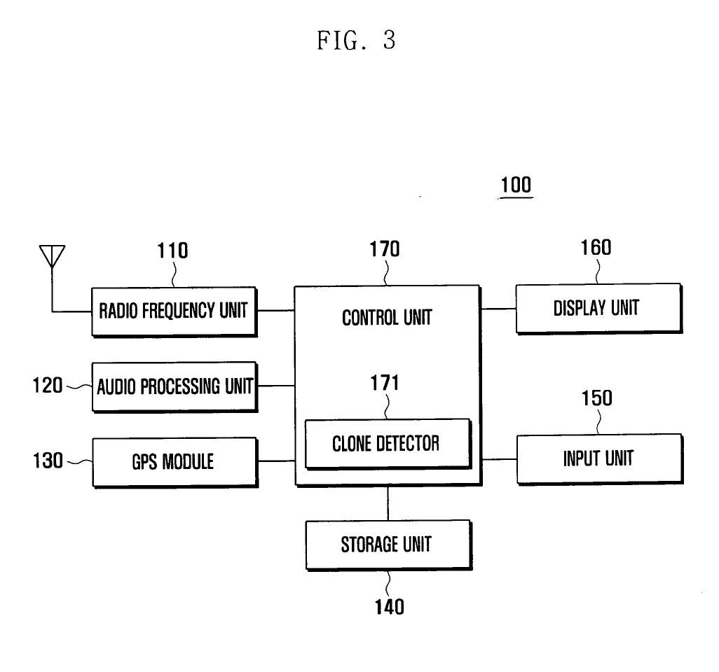

FIG. 3 is a block diagram illustrating the mobile terminal 100 capable of clone detection according to the procedure of FIG. 2. The mobile terminal 100 includes a radio frequency unit 110, an audio processing unit 120, a GPS module 130, a storage unit 140, an input unit 150, a display unit 160, and a control unit 170.

The radio frequency unit 110 sends and receives data for wireless communication of the mobile terminal 100. The radio frequency unit 110 may include a radio frequency transmitter for upconverting the frequency of a signal to be transmitted and amplifying the signal, and a radio frequency receiver for low-noise amplifying a received signal and downconverting the frequency of the signal. The radio frequency unit 110 may receive data through a wireless channel and forward the received data to the control unit 170, and may transmit data from the control unit 170 through the wireless channel. In particular, the radio frequency unit 110 sends the current location and time data of the mobile terminal 100 to the mobile communication system 200, and receives the previous location and time data of the mobile terminal 100 from the mobile communication system 200.

The audio processing unit 120 may include a coder/decoder (codec). The codec includes a data codec for processing packet data, and an audio codec for processing an audio signal such as a voice signal. The audio processing unit 120 converts a digital audio signal into an analog signal through the audio codec to reproduce the analog signal through a speaker, and also converts an analog audio signal from a microphone into a digital audio signal through the audio codec.

The GPS module 130 receives GPS signals from the GPS satellites 300. The GPS module 130 may include a high frequency section and a signal processing section. The high frequency section converts a signal of 1.2 GHz or 1.5 GHz received by an antenna into a lower-frequency signal that is easier to process. The signal processing section recovers the ranging codes and navigation message from a received GPS signal through despreading. In particular, the GPS module 130 determines the current location and time using the received GPS signals, and sends the current location and time data to the control unit 170.

The storage unit 140 stores programs and data necessary for the operation of the mobile terminal 100, and may include a program area and a data area. The storage unit 140 may be composed of volatile storage media and non-volatile storage media. The volatile storage media may include semiconductor memories such as a RAM, DRAM and SRAM, and the non-volatile storage media may include a hard disk. In particular, the storage unit 140 may store a program for clone detection, and a program for disabling the mobile terminal 100.

The input unit 150 generates a key signal corresponding to user manipulation and sends the key signal to the control unit 170. The input unit 150 may include a keypad including alphanumeric keys and direction keys arranged in a 3*4 or QWERTY format. The input unit 150 may further include a touch pad when the mobile terminal 100 has a touch screen capability. When the mobile terminal 100 is equipped with an image sensor and an acceleration sensor, these sensors may also act as an input means.

The display unit 160 may be realized using liquid crystal display (LCD) devices, organic light emitting diodes (OLED), or active matrix organic light emitting diodes (AMOLED). The display unit 160 visually provides various information such as menus, input data, and function-setting data to the user. For example, the display unit 160 may output a boot screen, an idle screen, a call handling screen, and other application screens for the mobile terminal 100.

The control unit 170 controls the overall operation of the mobile terminal 100. In particular, the control unit 170 includes a clone detector 171. The clone detector 171 computes the travel speed of the mobile terminal 100 using the current location and time data and the previous location and time data, and determines whether the mobile terminal 100 is a clone terminal by comparing the computed travel speed with a preset threshold speed.

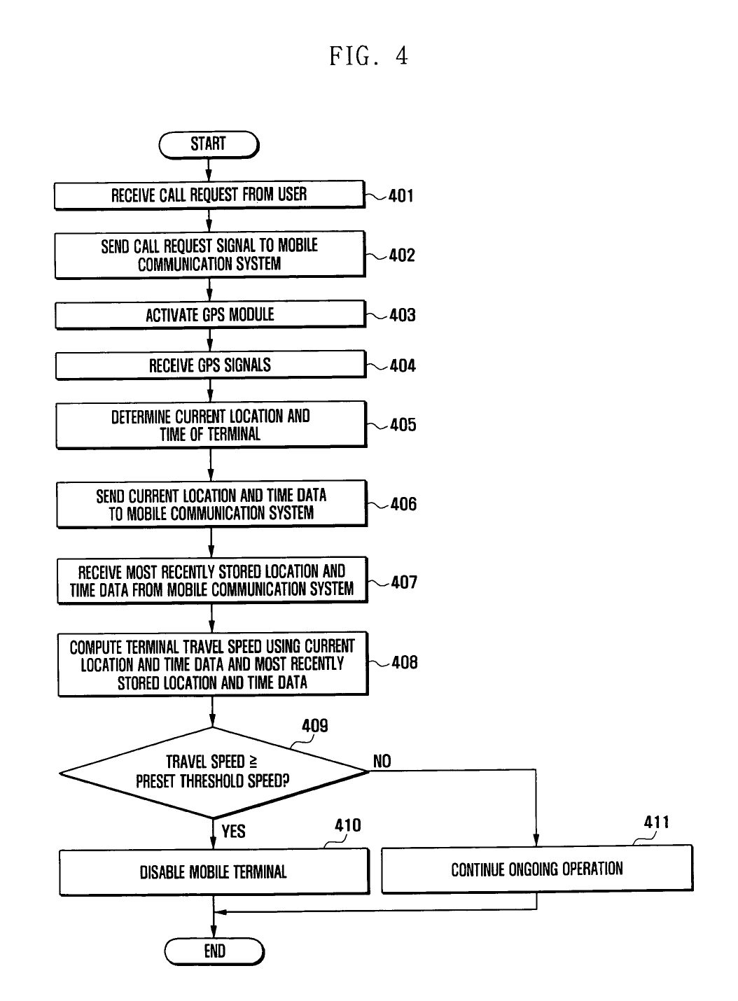

FIG. 4 is a flow chart of a clone detection procedure performed by the mobile terminal 100.

Referring to FIG. 4, when the user enters a ‘call’ key of the input unit 150, the control unit 170 receives a call request from the input unit 150 (401). The control unit 170 controls the sending of a call request signal by radio frequency unit 110 to the mobile communication system 200 (402). Alternatively, the control unit 170 may send a call request signal together with the current location and time data to the mobile communication system 200 later at block 406.

The control unit 170 activates the GPS module 130 (403), and controls the reception of GPS signals by GPS module 130 from the GPS satellites 300 (404). The control unit 170 controls the determination of the current location and time by the GPS module 130 using the received GPS signals (405). Here, the current location is specified by latitude and longitude. If the GPS module 130 is already activated when the ‘call’ key is entered, block 403 may be skipped.

The control unit 170 controls the sending of the current location and time data by the radio frequency unit 110 to the mobile communication system 200 (406). The control unit 170 controls the reception of the most recent location and time data prior to the current time by the radio frequency unit 110 from the mobile communication system 200 as the previous location and time data (407). Here, the previous location and time data is the most recent location and time data of the mobile terminal 100 that is stored prior to the current location and time in the mobile communication system 200. The current location and time data and the previous location and time data may have originated from different mobile terminals that are regarded as being identical (i.e., original terminal and clone terminal). Like the current location, the previous location is specified by latitude and longitude.

The clone detector 171 of the control unit 170 computes the travel speed of the mobile terminal 100 on the basis of the current location and time and the previous location and time data (408). Here, the clone detector 171 may find the distance between the current location and previous location using latitude and longitude values, find the time difference using the current and previous time, and compute the travel speed by dividing the distance by the time difference.

The clone detector 171 determines whether the computed travel speed is greater than or equal to a preset threshold speed (409). The threshold speed may be set to a value close to the maximum travel speed of a subscriber carrying a mobile terminal. When the travel speed is greater than or equal to the threshold speed, the clone detector 171 regards the mobile terminal 100 as having been clone (that is, the mobile terminal 100 may be an original terminal or a clone terminal) and disables the mobile terminal 100 (410). A program for disabling the mobile terminal 100 is stored in the storage unit 140, and the clone detector 171 may execute the disabling program. For example, the clone detector 171 may format the program area and data area of the storage unit 140 to disable the mobile terminal 100. When the travel speed is less than the threshold speed, the clone detector 171 regards the mobile terminal 100 as not having been clone and causes the ongoing operation to be continued (411). For example, when a call is in progress through the radio frequency unit 110, call processing is continued.

Alternatively, when the mobile terminal 100 is determined to have been clone, the control unit 170 may control the display of an alert message “clone terminal” by the display unit 160 at block 410 instead of disablement.

As described above, when the mobile terminal 100 is a clone terminal, the perpetrator can no longer utilize the mobile terminal 100. When the mobile terminal 100 is determined to have been clone, the legitimate subscriber can prevent invasion of privacy.

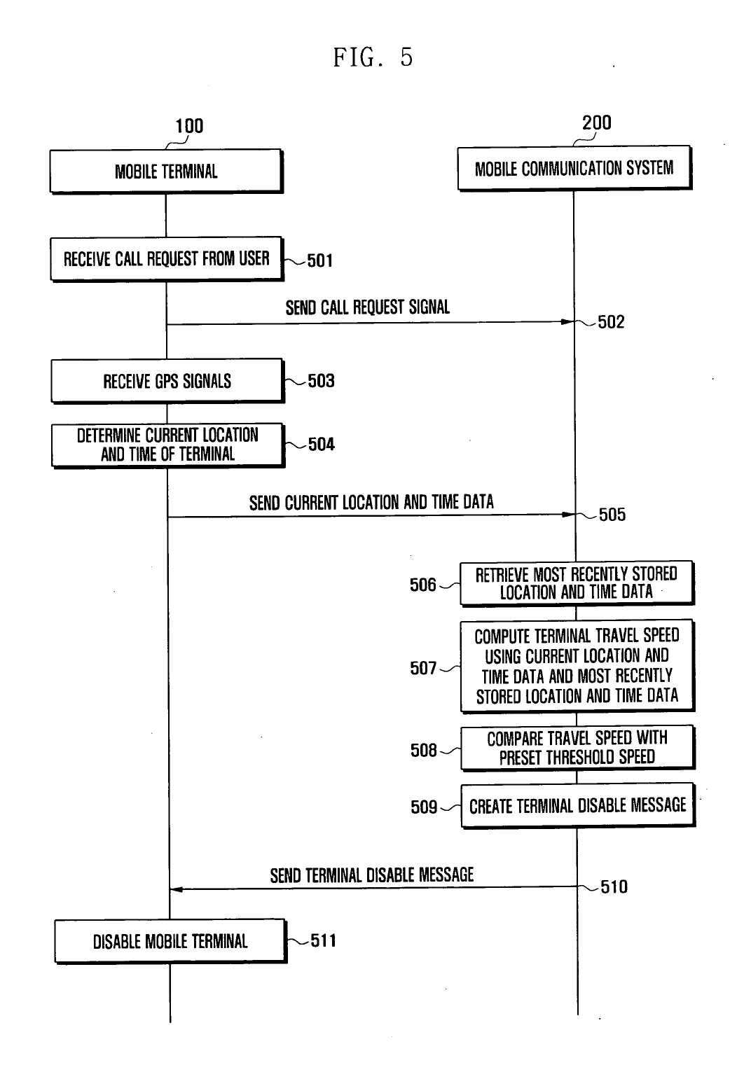

FIG. 5 is a sequence diagram illustrating a procedure for detecting a clone mobile terminal in the clone detection system according to the second embodiment of the present invention. FIG. 5 is focused on the mobile terminal 100 and mobile communication system 200.

Referring to FIG. 5, the mobile terminal 100 receives a call request from the user (501). The user may make a call request by entering a ‘call’ key of the mobile terminal 100. The mobile terminal 100 sends a call request signal to the mobile communication system 200 (502). Alternatively, the mobile terminal 100 may send a call request signal together with the current location and time data to the mobile communication system 200 later at block 505.

The mobile terminal 100 receives GPS signals from the GPS satellites 300 (503). The mobile terminal 100 may activate the GPS module 130 to receive GPS signals. The mobile terminal 100 determines its current location and time using the received GPS signals (504). The mobile terminal 100 sends the current location and time data to the mobile communication system 200 (505). Upon reception of the current location and time data from the mobile terminal 100, the mobile communication system 200 retrieves the most recent location and time data of the mobile terminal 100 stored prior to the current time (previous location and time data) and stores the received current location and time data (506). Specifically, the mobile communication system 200 includes a location information database, which stores location information of mobile terminals matched with time information. The mobile communication system 200 retrieves the most recent location and time data of the mobile terminal 100 from the location information database. Here, the location and time data received from the mobile terminal 100 and the location and time data retrieved from the location information database may have originated from different mobile terminals that are regarded as being identical (i.e., original terminal and clone terminal). The mobile communication system 200 computes the travel speed of the mobile terminal 100 on the basis of the current location and time data and the previous location and time data (507). Here, location data includes latitude and longitude. The mobile communication system 200 may find the distance between the current location and previous location using latitude and longitude values in the current and previous location data, find the time difference using the current and previous time data, and compute the travel speed of the mobile terminal 100 by dividing the distance by the time difference.

The mobile communication system 200 compares the computed travel speed with a preset threshold speed (508). As in the first embodiment, the threshold speed may be set to a value greater (but not much greater) than the maximum travel speed of a subscriber carrying a mobile terminal. When the travel speed is greater than the threshold speed, the mobile communication system 200 creates a disable message for disabling the mobile terminal 100 (509), and sends the disable message to the mobile terminal 100 (510). For example, the disable message may contain a format command for formatting the internal storage unit. Upon reception of the disable message, the mobile terminal 100 disables itself according to the command in the disable message (511).

Alternatively, when the travel speed is greater than the threshold speed, the mobile communication system 200 may create a notification message indicating “clone terminal” and send the notification message to the mobile terminal 100 at blocks 509 and 510.

In the second embodiment, the clone detection function is performed by the mobile communication system 200. Next, a description is given of components in the mobile communication system 200 performing clone detection.

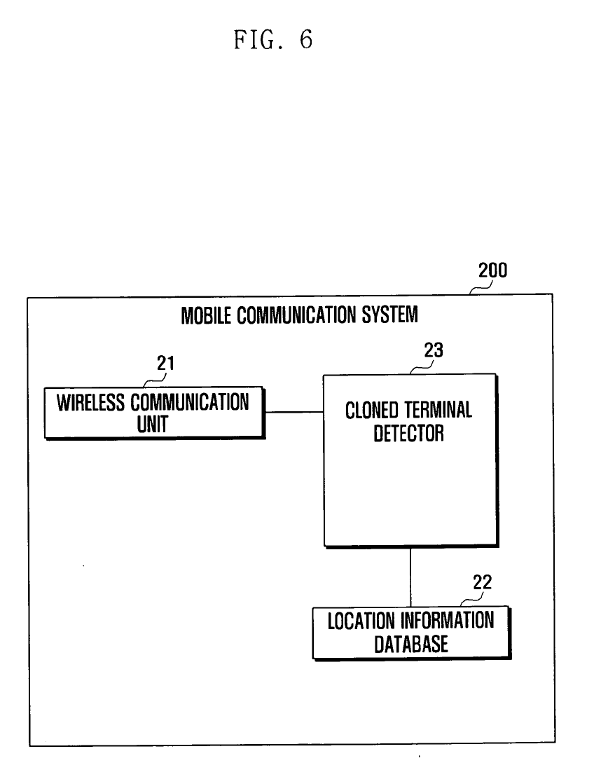

FIG. 6 illustrates components of the mobile communication system 200 implementing the procedure of detecting a clone mobile terminal. The mobile communication system 200 includes a wireless communication unit 21, a location information database 22, and a clone terminal detector 23. As described before, the mobile communication system 200 may include a base station, a base station controller, a mobile switching center, a home location register, and a visitor location register. The wireless communication unit 21, location information database 22, and clone terminal detector 23 may reside in one of the base station, base station controller, mobile switching center, home location register and visitor location register, or may be externally connected thereto as a server.

The wireless communication unit 21 receives current location and time data from the mobile terminal 100. The location information database 22 stores location and time data of the mobile terminal 100. The location information database 22 may maintain only the two most recent location and time data for each mobile terminal, or may maintain all location and time data received during a given time period. The clone terminal detector 23 determines whether the mobile terminal 100 is a clone terminal. The clone terminal detector 23 computes the travel speed of the mobile terminal 100 using the current location and time data and the previous location and time data, and determines whether the mobile terminal 100 is a clone terminal by comparing the travel speed with a preset threshold speed.

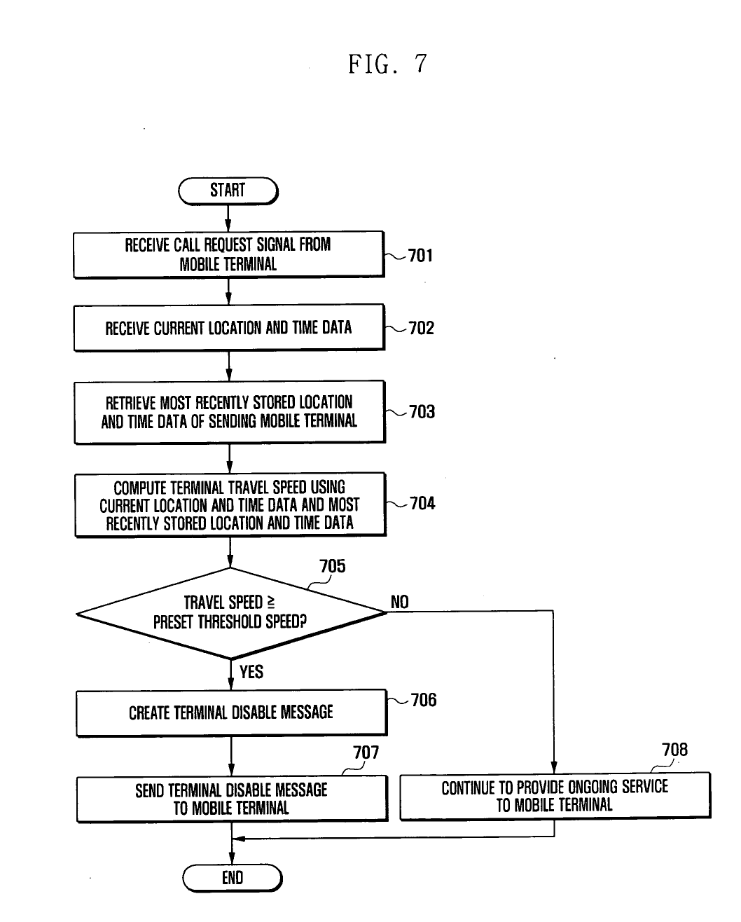

FIG. 7 is a flow chart of a clone detection procedure performed by the mobile communication system 200.

Referring to FIG. 7, the clone terminal detector 23 controls the reception of a call request signal from the mobile terminal 100 by the wireless communication unit 21 (701). The clone terminal detector 23 controls the reception of the current location and time data from the mobile terminal 100 by wireless communication unit 21 (702). The clone terminal detector 23 may receive the current location and time data together with the call request signal. Here, the current location data includes latitude and longitude.

The clone terminal detector 23 retrieves the most recent location and time data of the mobile terminal 100 stored prior to the current time (previous location and time data) from the location information database 22 (703). Here, the current location and time data received from the mobile terminal 100 and the previous location and time data retrieved from the location information database 22 may have originated from different mobile terminals that are regarded as being identical (i.e., original terminal and clone terminal). The previous location data also includes latitude and longitude.

The clone terminal detector 23 computes the travel speed of the mobile terminal 100 on the basis of the current location and time data and the previous location and time data (704). The clone terminal detector 23 may find the distance between the current location and previous location using latitude and longitude values in the current and previous location data, find the time difference using the current and previous time data, and compute the travel speed of the mobile terminal 100 by dividing the distance by the time difference.

The clone terminal detector 23 determines whether the travel speed is greater than or equal to a preset threshold speed (705). The threshold speed may be set to a value greater (but not much greater) than the maximum travel speed of a subscriber carrying a mobile terminal. When the travel speed is greater than or equal to the threshold speed, the clone terminal detector 23 creates a disable message for disabling the mobile terminal 100 (706), and controls the sending of the disable message by the wireless communication unit 21 to the mobile terminal 100 (707). For example, the disable message may contain a format command that forces the mobile terminal 100 to format the internal storage unit. When the travel speed is less than the threshold speed, the clone terminal detector 23 regards the mobile terminal 100 as a legitimate terminal and continues to provide the ongoing service to the mobile terminal 100 (708).

Alternatively, when the travel speed is greater than or equal to the threshold speed, the clone terminal detector 23 may create a notification message indicating “clone terminal” and control the sending of the notification message by the wireless communication unit 21 to the mobile terminal 100 at blocks 706 and 707.

As described above, when the mobile terminal 100 is a clone terminal, the perpetrator can no longer utilize the mobile terminal 100. When the mobile terminal 100 is determined to have been clone, the legitimate subscriber can prevent invasion of privacy.

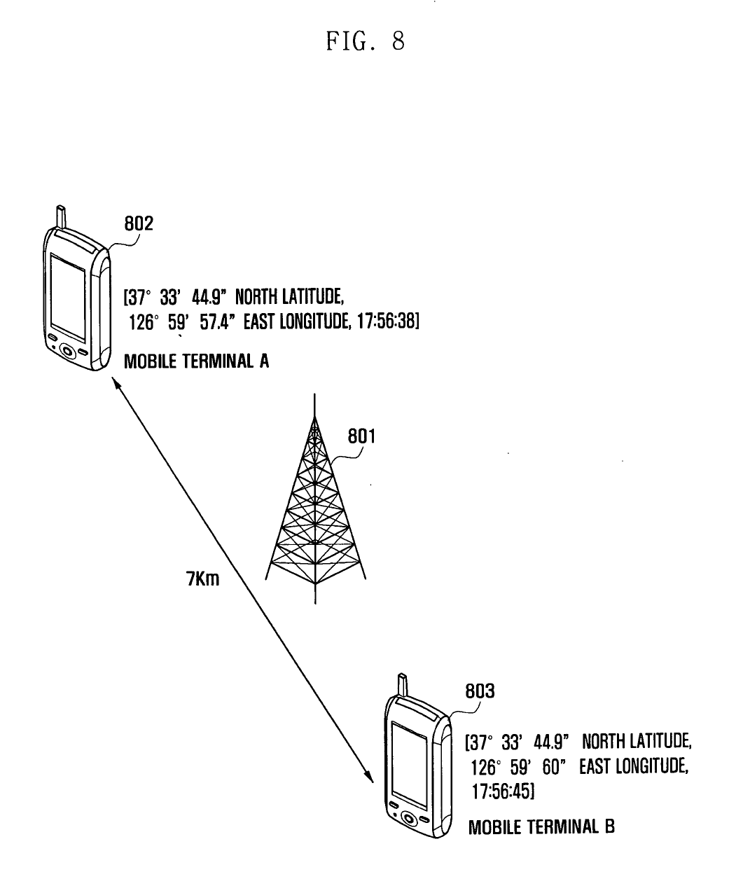

FIG. 8 illustrates detection of a clone mobile terminal on the basis of location information.

In FIG. 8, a base station 801 serves a mobile terminal 802 (terminal A) and another mobile terminal 803 (terminal B). Here, it is assumed that the mobile terminal 802 is an original terminal and the mobile terminal 803 is a clone terminal (a clone of the mobile terminal 802). The wireless communication unit 21, location information database 22, and clone terminal detector 23 (shown in FIG. 6) may be included in the base station 801 or may be connected to the base station 801 as a server.

The mobile terminal 802 sends the current location and time data (37°33′44.9″ north latitude, 126°59′57.4″ east longitude, 17:56:38) to the base station 801. The base station 801 receives the current location and time data from the mobile terminal 802, extracts the previous location and time data of the mobile terminal 802 and sends the previous location and time data to the mobile terminal 802, and stores the current location and time data as the most recent location and time data. As the mobile terminal 803 is a clone of the mobile terminal 802, the mobile terminal 802 and the mobile terminal 803 may receive the same signal from the base station 801. Upon reception of the previous location and time data, the mobile terminal 802 having sent the current location and time data computes its travel speed using the current location and time data and the previous location and time data and determines whether the travel speed is greater than the threshold speed. Here, it is assumed that the travel speed of the mobile terminal 802 is less than the threshold speed. Upon reception of the previous location and time data, the mobile terminal 803 having not sent the current location and time data ignores the received previous location and time data.

Thereafter, the mobile terminal 803 sends the current location and time data (37°33′44.9″ north latitude, 126°59′60″ east longitude, 17:56:45) to the base station 801. In response, the base station 801 sends the most recently stored location and time data (37°33′44.9″ north latitude, 126°59′57.4″ east longitude, 17:56:38 (originated from the mobile terminal 802 being regarded as identical to the mobile terminal 803)) to the mobile terminal 803 as the previous location and time data. The mobile terminal 802 may also receive this location and time data. Upon reception of the previous location and time data, the mobile terminal 803 computes its travel speed using the current location and time data (37°33′44.9″ north latitude, 126°69′60″ east longitude, 17:56:45) and the previous location and time data (37°33′44.9″ north latitude, 126°59′57.4″ east longitude, 17:56:38). When the distance between a location given by 37°33′44.9″ north latitude and 126°59′60″ east longitude and another location given by 37°33′44.9″ north latitude and 126°59′57.4″ east longitude is about 7 km and the time difference between 17:56:38 and 17:56:45 is 7 seconds, the mobile terminal 803 obtains a travel speed of 1 km/s. Even a subscriber on board an airplane cannot reach this speed. For example, when the threshold speed is set to 500 m/s, the mobile terminal 803 determines that the computed travel speed exceeds the threshold speed and disables itself.

The above clone detection procedure may also be performed by the base station 801. The base station 801 receives location and time data (37°33′44.9″ north latitude, 126°59′57.4″ east longitude, 17:56:38) from the mobile terminal 802, and receives location and time data (37°33′44.9″ north latitude, 126°59′60″ east longitude, 17:56:45) from the mobile terminal 803. At this time, the base station 801 regards the two pieces of location and time data as having originated from the same mobile terminal. The base station 801 computes the travel speed of the mobile terminal 802 or mobile terminal 803) using the two pieces of location and time data, and determines whether the travel speed is greater than or equal to the threshold speed. When the travel speed is greater than or equal to the threshold speed, the base station 801 creates a disable message and sends the disable message to the mobile terminal 802 or mobile terminal 803. Each of the mobile terminal 802 and the mobile terminal 803 may receive the disable message and execute a procedure of disabling itself.

In the above description, the mobile terminal 100 sends and receives location data and time data to and from the mobile communication system 200. However, the present invention is not limited thereto. That is, the mobile terminal 100 may send and receive only location data to and from the mobile communication system 200, and each of the mobile terminal 100 and the mobile communication system 200 may record the time at which location data is sent and the time at which location data is received. The recorded time data may be used to compute the travel speed of the mobile terminal 100.

The clone detection method of the present invention may be implemented as computer programs and may be stored in various computer readable storage media. The computer readable storage media may store program instructions, data files, data structures, and combinations thereof. The program instructions may include instructions developed specifically for the present invention and existing general-purpose instructions.

The computer readable storage media may include magnetic media such as a hard disk and floppy disk, optical media such as a CD-ROM and DVD, magneto-optical media such as a floptical disk, and memory devices such as a ROM and RAM. The program instructions may include machine codes produced by compilers and high-level language codes executable through interpreters.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of clone detection for a mobile terminal, comprising:
determining, when a call request is made, by the mobile terminal, a current location and time;
sending the current location and time data to a mobile communication system;
receiving a pre-stored location and time data of the mobile terminal from the mobile communication system;
computing a travel speed of the mobile terminal using the current location and time data and the pre-stored location and time data;
comparing the computed travel speed with a preset threshold speed; and
determining, when the travel speed is greater than or equal to the threshold speed, that the mobile terminal is a clone terminal.

2. The method of claim 1, wherein determining the current location and time comprises:
receiving Global Positioning System (GPS) signals from GPS satellites; and
determining the current location and time of the mobile terminal using the received GPS signals.

3. The method of claim 1, further comprising sending, before sending the current location and time data, a call request signal to the mobile communication system.

4. The method of claim 1, wherein sending the current location and time data further comprises sending a call request signal to the mobile communication system.

5. The method of claim 1, wherein the pre-stored location and time data received by the mobile terminal corresponds to the most recently stored location and time data except for the current location and time data among multiple pieces of location and time data of the mobile terminal stored in the mobile communication system.

6. The method of claim 1, further comprising disabling, when the travel speed is greater than or equal to the threshold speed, the mobile terminal.

7. A mobile terminal comprising:
a GPS module configured to receive Global Positioning System (GPS) signals from GPS satellites;
a radio frequency unit configured to send a current location and time data to a mobile communication system, and receive a pre-stored location and time data of the mobile terminal from the mobile communication system; and
a control unit configured to determine a current location and time of the mobile terminal using the GPS signals received through the GPS module, compute a travel speed of the mobile terminal using the current location and time data and the pre-stored location and time data, compare the computed travel speed with a preset threshold speed, and determine, when the travel speed is greater than or equal to the threshold speed, that the mobile terminal is a clone terminal.

8. The mobile terminal of claim 7, wherein the control unit is configured to disable the mobile terminal when the mobile terminal is determined to be a clone terminal.

9. A method of clone terminal detection for a mobile communication system, comprising:
receiving a current location and time data of a mobile terminal from the mobile terminal;
retrieving a location and time data of the mobile terminal pre-stored prior to reception of the current location and time data;
computing a travel speed of the mobile terminal using the current location and time data and the pre-stored location and time data;
comparing the computed travel speed with a preset threshold speed; and
determining, when the travel speed is greater than or equal to the threshold speed, that the mobile terminal is a clone terminal.

10. The method of claim 9, further comprising receiving, before receiving the current location and time data, a call request signal from the mobile terminal.

11. The method of claim 9, wherein receiving the current location and time data further comprises receiving a call request signal from the mobile terminal.

12. The method of claim 9, wherein the retrieved location and time data of the mobile terminal corresponds to the most recently stored location and time data except for the current location and time data among multiple pieces of location and time data of the mobile terminal stored in the mobile communication system.

13. The method of claim 9, further comprising:
creating, when the travel speed is greater than or equal to the threshold speed, a message for disabling the mobile terminal; and
sending the created disable message to the mobile terminal.

14. A mobile communication system comprising:
a wireless communication unit configured to receive a current location and time data of a mobile terminal from the mobile terminal;
a location information database configured to store one or more pieces of location and time data received from the mobile terminal;
a clone terminal detector configured to retrieve the most recently stored location and time data of the mobile terminal except for the current location and time data from the location information database, compute a travel speed of the mobile terminal using the received current location and time data and the retrieved most recently stored location and time data, compare the computed travel speed with a preset threshold speed, and determine, when the travel speed is greater than or equal to the threshold speed, that the mobile terminal is a clone terminal.

15. The mobile communication system of claim 14, wherein when the travel speed is greater than or equal to the threshold speed, the clone terminal detector is configured to create a message for disabling the mobile terminal and instructs the wireless communication unit to send the created disable message to the mobile terminal.

16. The mobile communication system of claim 15, wherein the disable message comprises a format command for formatting an internal storage unit of the mobile terminal.

17. The mobile communication system of claim 14, wherein when the travel speed is greater than or equal to the threshold speed, the clone terminal detector is configured to create a message indicating that the mobile terminal is a clone terminal and instructs the wireless communication unit to send the created message to the mobile terminal.

18. The method of claim 1, further comprising sending, when the travel speed is greater than or equal to the threshold speed, a message to the mobile terminal indicating that the mobile terminal is a clone terminal.

19. The mobile terminal of claim 7, wherein the control unit is configured to send a message to the mobile terminal indicating that the mobile terminal is a clone terminal when the mobile terminal is determined to be a clone terminal.

20. The method of claim 9, further comprising:
creating, when the travel speed is greater than or equal to the threshold speed, a message indicating that the mobile terminal is a clone terminal; and
sending the message to the mobile terminal.
